(19) United States
(12) Patent Application Publication
(10) Pub. No.: US 2016/0269951 A1
(43) Pub. Date: Sep. 15, 2016

(54) Positioning method and device, and storage medium

(71) Applicant: ZTE Corporation, Shenzhen (CN)

(72) Inventors: Kunjun Jiang, Shenzhen (CN); Xianyan Wang, Shenzhen (CN)

(21) Appl. No.: 15/031,664

(22) PCT Filed: Aug. 11, 2014
(86) PCT No.: PCT/CN2014/084129

§ 371 Date: Apr. 22, 2016

(30) Foreign Application Priority Data
Oct. 22, 2013 (CN) 201310499423.8

(51) Int. Cl. H04W 36/08; H04W 4/02; H04W 92/10

(52) U.S. Cl. CPC H04W 36/08; H04W 92/10; H04W 4/025

(57) ABSTRACT

Disclosed is a positioning method, comprising: when a terminal is switched, judging whether the terminal is performing periodic enhanced cell identification (E-CID) positioning; and when it is determined that the terminal is performing periodic E-CID positioning, carrying a periodic positioning cell of the terminal in a switching request message sent to a target side. Also disclosed at the same time are a positioning device and a storage medium. In the embodiments of the present invention, a target side can carry out related measurements of periodic positioning for a terminal on time, so that the time delay of periodic positioning is greatly optimized, and the length of time needed for the target side to position the terminal is once again reduced, thereby providing a better periodic positioning experience of the terminal for a user.

### TECHNICAL FIELD

The disclosure relates to the field of communications, and in particular to a positioning method and device, and a storage medium.

### BACKGROUND

A Cell-ID (CID) positioning technology is to estimate a current location of User Equipment (UE) according to location coordinates of a serving cell where the UE is located and relevant measurement information of the UE and the cell, while an Enhanced Cell-ID (E-CID) positioning technology is a technology for improving the positioning precision under the assistance of relevant measurement of neighbouring cells or other UE on the basis of the CID positioning technology.

The E-CID positioning technology is mainly classified into an on-demand type and a periodical type, and for the periodical type, an Evolved Serving Mobile Location Centre (E-SMLC) issues a periodical positioning request to an Evolved Node B (eNB), to request the eNB to perform relevant positioning measurement on designated UE; in addition, the content of the request includes information such as UE identification information, measurement reporting period, measurement contents and the like; the eNB starts relevant positioning measurement according to the content of the request, and periodically reports relevant measurement results to the E-SMLC to implement dynamic and real-time positioning.

At present, when S1 or X2 handover occurs on the UE, after the UE is handovered to a target eNB, the target eNB fails to acquire the periodical positioning information of the current UE in time, reporting of the periodical positioning information will not be continuously carried out any more, that is, the target eNB cannot continuously report the periodical positioning information until the E-SMLC re-issues a periodical positioning request to the target eNB, which in turn results in a relatively long time delay.

### SUMMARY

To solve the technical problem described above, the embodiment of the disclosure provides a positioning method and device, which can optimize a periodical User Equipment (UE) positioning time delay and improve user experiences.

The technical solutions of the embodiment of the disclosure are implemented as follows.

A positioning method is provided, which includes:

when a handover occurs on UE, it is determined whether the UE is subjected to periodical Enhanced Cell Identification (E-CID) positioning; and

when it is determined that the UE is subjected to periodical E-CID positioning, a handover request carrying a periodical positioning information element of the UE is transmitted to a target evolved Node B (eNB).

In an embodiment, the handover request may be an S1 handover request or an X2 handover request.

In an embodiment, the method may further include: before the step that the handover request carrying the periodical positioning information element of the UE is transmitted to the target eNB,

the type of the handover for the UE is determined;

when the handover is an S1 handover, a container of an S1 handover request to be transmitted to the target eNB carries the periodical positioning information element of the UE;

when the handover is an X2 handover, an X2 handover request to be transmitted to the target eNB directly carries the periodical positioning information element of the UE.

In an embodiment, the periodical positioning information element may include at least one of the following information:

LTE positioning protocol A session ID information, evolved serving mobile location centre measurement ID information, measurement period information, measurement contents and route ID information.

In an embodiment, the method may further include:

after receiving the handover request carrying the periodical positioning information element of the UE, the target eNB performs relevant positioning measurement according to the periodical positioning information element, and reports relevant positioning measurement results.

A positioning device is further provided, which includes a determination module and an adjustment module, in which:

the determination module is configured to, when a handover occurs on UE, determine whether the UE is subjected to periodical E-CID positioning;

the adjustment module is configured to, when it is determined that the UE is subjected to periodical E-CID positioning, transmit a handover request carrying a periodical positioning information element of the UE to a target evolved eNB.

In an embodiment, the handover request may be an S1 handover request or an X2 handover request.

In an embodiment, the adjustment module may be further configured to:

determine the type of handover for the UE; when the handover is an S1 handover, make a container of an S1 handover request to be transmitted to the target eNB carry the periodical positioning information element of the UE; when the handover is an X2 handover, make an X2 handover request to be transmitted to the target eNB directly carry the periodical positioning information element of the UE.

In an embodiment, the periodical positioning information element may include at least one of the following information:

LTE positioning protocol A session ID information, evolved serving mobile location centre measurement ID information, measurement period information, measurement contents and route ID information.

In an embodiment, the device may further include a receiving module configured to receive relevant positioning measurement results reported by the target eNB after the target eNB receives the handover request carrying the periodical positioning information element of the UE and performs relevant positioning measurement according to the periodical positioning information element.

A storage medium is provided, in which computer programs are stored, the computer programs being configured to execute the positioning method above.

According to the positioning method and device provided by the disclosure, when a handover occurs on UE, it is determined whether the UE is subjected to periodical E-CID positioning; and when it is determined that the UE is subjected to periodical E-CID positioning, a handover request carrying a periodical positioning information element of the UE is transmitted to a target eNB. In this way, when the UE is subjected to an S1 or X2 handover, it is possible to deliver fast the periodical positioning information to the target eNB, so that the target eNB can perform in time measurement related to the periodical positioning of the UE; therefore, the periodical positioning time delay is greatly optimized, the time for re-positioning the UE is shortened, and a better periodical UE positioning experience is provided to a user.

### BRIEF DESCRIPTION OF THE DRAWINGS

FIG. 1 is a flowchart for implementing a positioning method according to an embodiment of the disclosure;

FIG. 2 is a flowchart for implementing periodical User Equipment (UE) positioning when UE is subjected to an S1 handover according to an embodiment of the disclosure;

FIG. 3 is a flowchart for implementing periodical UE positioning when UE is subjected to an X2 handover according to an embodiment of the disclosure; and

FIG. 4 is a schematic structural diagram of a positioning device according to an embodiment of the disclosure.

### DETAILED DESCRIPTION

The disclosure is further described below with accompanying drawings and specific embodiments in detail.

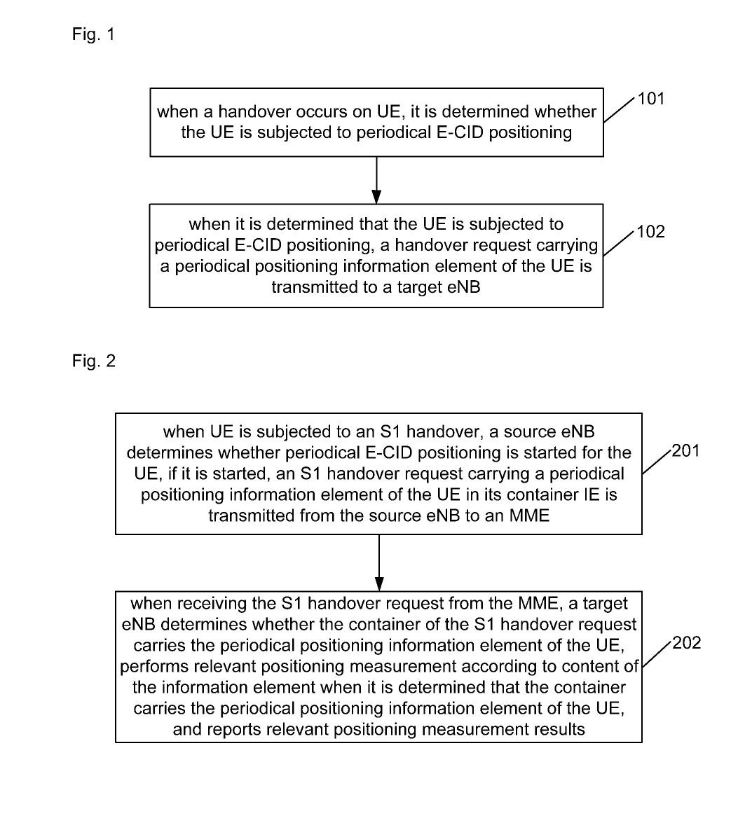

FIG. 1 is a flowchart for implementing a positioning method according to an embodiment of the disclosure. As shown in FIG. 1, the method includes the steps as follows.

Step 101: when a handover occurs on User Equipment (UE), it is determined whether the UE is subjected to periodical Enhanced Cell Identification (E-CID) positioning;

specifically, when the handover occurs on the UE, a source eNB may determine whether the UE is subjected to periodical E-CID positioning.

Step 102: when it is determined that the UE is subjected to periodical E-CID positioning, a handover request carrying a periodical positioning information element of the UE is transmitted to a target eNB.

Specifically, the handover request is an S1 handover request or an X2 handover request.

Specifically, the method further includes: before the step that the handover request carrying the periodical positioning information element of the UE is transmitted to the target eNB,

the type of handover for the UE is determined;

when the handover is an S1 handover, a container of an S1 handover request to be transmitted to the target eNB carries the periodical positioning information element of the UE;

when the handover is an X2 handover, an X2 handover request to be transmitted to the target eNB directly carries the periodical positioning information element of the UE.

Here, the S1 handover request is the “HANDOVER REQUIRED” described in the Long Term Evolution (LTE) protocol; the X2 handover request is the “HANDOVER REQUEST” described in the LTE protocol.

Specifically, the periodical positioning information element includes at least one of the following information:

LTE Positioning Protocol A (LPPA) session Identity (ID) information, Evolved Serving Mobile Location Centre (E-SMLC) measurement ID information, measurement period information, measurement contents and route ID information.

Here, the periodical positioning information element may further include other newly added information supplemented to support the periodical E-CID in protocols 36.455 and 36.413 in the LTE protocol.

Furthermore, after the step that the handover request carrying the periodical positioning information element of the UE is transmitted to the target eNB, the method further includes:

after receiving the handover request carrying the periodical positioning information element of the UE, the target eNB performs relevant positioning measurement according to the periodical positioning information element, and reports relevant positioning measurement results.

Here, the target eNB starts relevant periodical positioning measurement in time according to contents of the periodical positioning information element and descriptions of protocols such as 36.455 and 36.413, and then reports the measurement results to the E-SMLC in time so as to provide a better periodical UE positioning experience to a user.

FIG. 2 is a flowchart for implementing periodical User Equipment (UE) positioning when UE is subjected to an S1 handover according to an embodiment of the disclosure. As shown in FIG. 2, the flow includes steps as follows.

Step 201: when UE is subjected to an S1 handover, a source eNB determines whether periodical E-CID positioning is started for the UE, if it is started, an S1 handover request carrying a periodical positioning information element of the UE in its container IE (Source eNB to target eNB Transparent Container IE) is transmitted from the source eNB to a Mobility Management Entity (MME) ;

herein, when the UE is subjected to the S1 handover, the E-CID periodical positioning information is required to be carried in the container from the source eNB to the target eNB so that a core network can transmit transparently the E-CID periodical positioning information to the target eNB.

Step 202: when receiving the S1 handover request from the MME, a target eNB determines whether the container of the S1 handover request carries the periodical positioning information element of the UE, performs relevant positioning measurement according to content of the information element when it is determined that the container carries the periodical positioning information element of the UE, and reports relevant positioning measurement results.

Here, after the target eNB receives the S1 handover request, relevant positioning measurement performed according to the content of the information element and specific processing flow of measurement result processing may be referred to the protocol 36.455, and the detailed description thereof will be omitted herein.

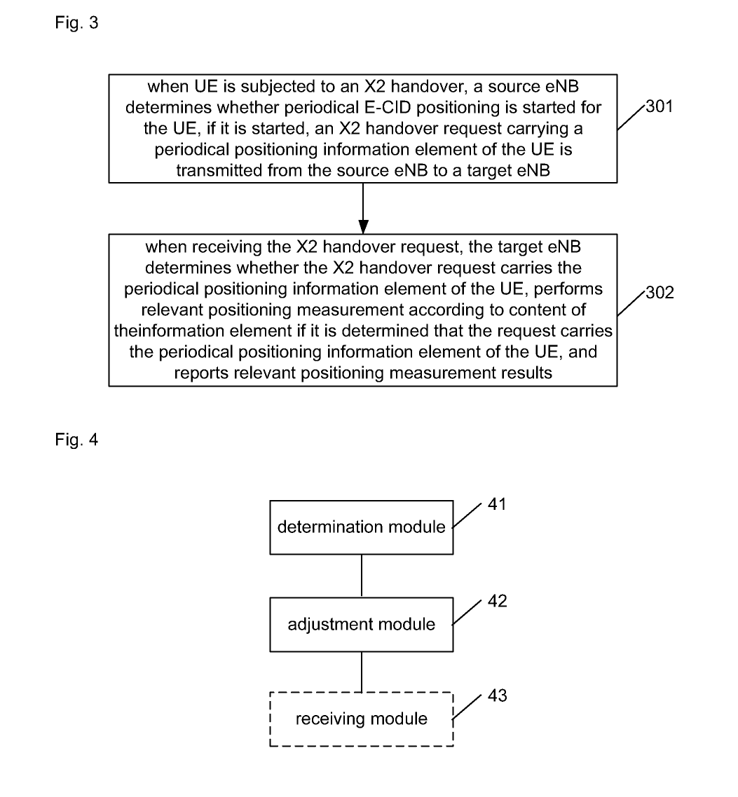

FIG. 3 is a flowchart for implementing periodical UE positioning when UE is subjected to an X2 handover according to an embodiment of the disclosure. As shown in FIG. 3, the flow includes steps as follows.

Step 301: when UE is subjected to an X2 handover, a source eNB determines whether periodical E-CID positioning is started for the UE, if it is started, an X2 handover request carrying a periodical positioning information element of the UE is transmitted from the source eNB to a target eNB;

Step 302: when receiving the X2 handover request, the target eNB determines whether the X2 handover request carries the periodical positioning information element of the UE, performs relevant positioning measurement according to content of the information element if it is determined that the request carries the periodical positioning information element of the UE, and reports relevant positioning measurement results.

Here, after the target eNB receives the X2 handover request, relevant positioning measurement performed according to the content of the information element and specific processing flow of measurement result processing may be referred to the protocol 36.455, and the detailed description thereof will be omitted herein.

FIG. 4 is a schematic structural diagram of a positioning device according to an embodiment of a disclosure. As shown in FIG. 4, the device includes a determination module 41 and an adjustment module 42, in which:

the determination module 41 is configured to, when a handover occurs on UE, determine whether the UE is subjected to periodical E-CID positioning;

the adjustment module 42 is configured to, when it is determined that the UE is subjected to periodical E-CID positioning, transmit a handover request carrying a periodical positioning information element of the UE to a target eNB.

Here, the handover request is an S1 handover request or an X2 handover request.

Specifically, the adjustment module 42 is further configured to:

determine the type of handover for the UE; when the handover is an S1 handover, make a container of an S1 handover request to be transmitted to the target eNB carry the periodical positioning information element of the UE; when the handover is an X2 handover, make an X2 handover request to be transmitted to the target eNB directly carry the periodical positioning information element of the UE.

Herein, the periodical positioning information element includes at least one of the following information:

LPPA session ID information, E-SMLC measurement ID information, measurement period information, measurement contents and route ID information.

Preferably, the device further includes a receiving module 43 configured to receive relevant positioning measurement results reported by the target eNB after the target eNB receives the handover request carrying the periodical positioning information element of the UE and performs relevant positioning measurement according to the periodical positioning information element.

Here, the positioning device may be arranged in a base station.

The embodiment of the disclosure further discloses a storage medium, in which computer programs are stored, the computer programs being configured to execute the positioning methods of all the embodiments above.

The description above is only preferred embodiments of the disclosure, but not intended to limit the scope of protection of the disclosure. Thus, any modification, equivalent replacement, improvement and the like made as per the principle of the disclosure shall fall within the scope of protection of the disclosure.

### INDUSTRIAL APPLICABILITY

In the disclosure, when a handover occurs on UE, it is determined whether the UE is subjected to periodical E-CID positioning; and when it is determined that the UE is subjected to periodical E-CID positioning, a handover request carrying a periodical positioning information element of the UE is transmitted to a target eNB. In this way, when the UE is subjected to an S1 or X2 handover, it is possible to deliver fast the periodical positioning information to the target eNB, so that the target eNB can perform in time measurement related to the periodical positioning of the UE; therefore, the periodical positioning time delay is greatly optimized, the time for re-positioning the UE is shortened, and a better periodical UE positioning experience is provided to a user.

What is claimed is:

1. A positioning method, comprising:
when a handover occurs on User Equipment (UE), determining whether the UE is subjected to periodical Enhanced Cell Identification (E-CID) positioning; and
when it is determined that the UE is subjected to periodical E-CID positioning, transmitting a handover request carrying a periodical positioning information element of the UE to a target evolved Node B (eNB).

2. The method according to claim 1, wherein the handover request is an S1 handover request or an X2 handover request.

3. The method according to claim 2, further comprising, before transmitting the handover request carrying the periodical positioning information element of the UE to the target eNB,
determining the type of the handover for the UE;
when the handover is an S1 handover, making a container of an S1 handover request to be transmitted to the target eNB carry the periodical positioning information element of the UE;
when the handover is an X2 handover, making an X2 handover request to be transmitted to the target eNB directly carry the periodical positioning information element of the UE.

4. The method according to claim 1, wherein the periodical positioning information element comprises at least one of the following information:
long term evolution positioning protocol A session Identity (ID) information, evolved serving mobile location centre measurement ID information, measurement period information, measurement contents and route ID information.

5. The method according to claim 1, further comprising:
receiving the handover request carrying the periodical positioning information element of the UE, performing, by the target eNB, relevant positioning measurement according to the periodical positioning information element, and reporting relevant positioning measurement results.

6. A positioning device, comprising a determination module and an adjustment module,
wherein the determination module is configured to, when a handover occurs on User Equipment (UE), determine whether the UE is subjected to periodical Enhanced Cell Identification (E-CID) positioning; and
wherein the adjustment module is configured to, when it is determined that the UE is subjected to periodical E-CID positioning, transmit a handover request carrying a periodical positioning information element of the UE to a target evolved Node B (eNB).

7. The device according to claim 6, wherein the handover request is an S1 handover request or an X2 handover request.

8. The device according to claim 6, wherein the adjustment module is further configured to:
determine the type of the handover for the UE; when the handover is an S1 handover, make a container of an S1 handover request to be transmitted to the target eNB carry the periodical positioning information element of the UE; when the handover is an X2 handover, make an X2 handover request to be transmitted to the target eNB directly carry the periodical positioning information element of the UE.

9. The device according to claim 6, wherein the periodical positioning information element comprises at least one of the following information:
long term evolution positioning protocol A session Identity (ID) information, evolved serving mobile location centre measurement ID information, measurement period information, measurement contents and route ID information.

10. The device according to claim 6, further comprising a receiving module configured to receive relevant positioning measurement results reported by the target eNB after the target eNB receives the handover request carrying the periodical positioning information element of the UE and performs relevant positioning measurement according to the periodical positioning information element.

11. A storage medium having stored therein computer programs configured to execute a positioning method, the method comprising:
when a handover occurs on User Equipment (UE), determining whether the UE is subjected to periodical Enhanced Cell Identification (E-CID) positioning; and
when it is determined that the UE is subjected to periodical E-CID positioning, transmitting a handover request carrying a periodical positioning information element of the UE to a target evolved Node B (eNB).

12. The device according to claim 7, wherein the adjustment module is further configured to:
determine the type of the handover for the UE; when the handover is an S1 handover, make a container of an S1 handover request to be transmitted to the target eNB carry the periodical positioning information element of the UE; when the handover is an X2 handover, make an X2 handover request to be transmitted to the target eNB directly carry the periodical positioning information element of the UE.
